(19) United States
(12) Patent Application Publication
(10) Pub. No.: US 2005/0185542 A1
(43) Pub. Date: Aug. 25, 2005

(54) Optical disc recording apparatus, optical disc reproducing apparatus, and multi-layered optical disc

(75) Inventor: Munehiko Iwase, Tokyo (JP)

Correspondence Address: MCGINN & GIBB, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/063,639

(22) Filed: Feb. 24, 2005

(30) Foreign Application Priority Data
Feb. 25, 2004 (JP) 2004-50291

(51) Int. Cl. G11B 7/20

(52) U.S. Cl. 369/47.19; 369/94; 369/47.15

(57) ABSTRACT

Disclosed is an optical recording disc capable of limiting the redundancy of recorded information and reducing facility investments and manufacturing cost. The optical disc recording apparatus comprises a signal generator for generating a low-resolution image signal by sampling a high-resolution image signal at a predetermined rate, and generating a part of the high-resolution image signal except for the low-resolution image signal as a modified image signal; an encoder for encoding the low-resolution image signal with a first coding scheme to generate a first encoded signal; another encoder for encoding the modified image signal with a second coding scheme different from the first coding scheme to generate a second encoded signal; a signal modulator for modulating the first encoded signal and second encoded signal to generate a first modulated signal and a second modulated signal, respectively; and an optical pickup unit for writing the first modulated signal into a first recording layer of the multi-layered optical disc and writing the second encoded signal into a second recording layer of the multi-layered optical disc.

### BACKGROUND OF THE INVENTION

1. Field of the Invention

The present invention relates to a multi-layered optical disc having a plurality of recording layers, an optical disc recording apparatus for recording an image signal on the multi-layered optical disc, and an optical disc reproducing apparatus for reproducing an image signal from the multi-layered optical disc.

2. Description of the Related Art

In recent years, multi-layered optical discs having two or more recording layers have been developed for recording a larger amount of information. A recording density of optical discs has been increased by reducing the wavelength of light emitted from a light source, and by increasing the numerical aperture (NA) of an objective lens. Further, next-generation standards have been proposed for a multi-layered optical disc having large memory capacity and high-recording density. On the other hand, next-generation moving image coding schemes such as H.264 (ISO/IEC14496-10) have been proposed for information to be recorded on optical discs. Since it is assumed that current standards exist together with the next-generation standards for some period in future, optical disc recording/reproducing apparatuses and multi-layered optical discs are required not only to have the performance conforming to the new next-generation standards, but also to have the performance conforming to existing standards (hereinafter called the “backward compatibility”) in such a period.

A known optical disc having the backward compatibility is disclosed, for example, in Japanese Patent Kokai No. 2001-176129. FIG. 1 is a cross-sectional view schematically illustrating the structure of an optical disc 100 disclosed in Japanese Patent Kokai No. 2001-176129. The optical disc 100 comprises a first substrate 111 made of an optical material such as acrylic-based resin, a middle-density recording layer 112 including a metal thin film formed on a main surface of the first substrate 111, and an adhesive layer 113 formed on the middle-density recording layer 112. On the main surface of the first substrate 111, a land and groove pattern conforming to the DVD standard, by way of example, is formed. The metal thin film which forms part of the middle-density recording layer 112 has a reflectivity of 70% or higher to incident light L1 at a first wavelength λ₁. The optical disc 100 further comprises a second substrate 114 in contact with the adhesive layer 113, a high-density recording layer 115 including a reflective layer formed on the second substrate 114, and a protective layer 116 formed on the high-density recording layer 115. The main surface of the second substrate 114 forms a land and groove pattern conforming to a next-generation high-density recording standard, and has guide grooves or recording pits. The reflective film which forms part of the high-density recording layer 115 has a reflectivity of 70% or higher to incident light L2 at a second wavelength λ₂. The protective layer 116 is made of a material transparent to the light L2 at the second wavelength λ₂, for example, an ultraviolet curing resin.

With the optical disc 100 structured as described above, data conforming to the existing DVD standard can be recorded on the middle-density recording layer 112, while data conforming to the next-generation high density recording standard can be recorded on the high-density recording layer 115. For reading data conforming to the DVD standard from the optical disc 100, the middle-density recording layer 112 is irradiated with focused reading light L1 at wavelength λ₁ from the first substrate 111, and reflected light therefrom is detected to read data recorded on the middle-density recording layer 112. On the other hand, for reading data conforming to the next-generation high density recording standard from the optical disc 100, the high-density recording layer 115 is irradiated with focused reading light L2 at wavelength λ₂ from the protective layer 116, and reflected light therefrom is detected to read data recorded on the high-density recording layer 115. In this way, the optical disc 100 has the backward compatibility which supports both the existing DVD standard and the next-generation standard.

A process for manufacturing the optical disc 100 is outlined below. First, a land and groove pattern conforming to the DVD standard is formed on the main surface of the first substrate 111. Next, a metal thin film is deposited on the main surface of the first substrate 111 by a vacuum vapor deposition method or a sputtering method to form the middle-density recording layer 112. On the other hand, a land and groove pattern conforming to the next-generation standard is formed on the main surface of the second substrate 114. Next, a high-density recording layer 115 made of a metal thin film is formed on the main surface of the second substrate 114 by a vacuum vapor deposition method or a sputtering method, and the protective layer 116 is formed on the high-density recording layer 115 by a dipping method, a vacuum vapor deposition method, or the like. Then, the first substrate 111 is adhered to the second substrate 114 through the adhesion layer 113 to complete the optical disc 100.

For recording image data of the same contents on the optical disc 100, a high definition image conforming to the next-generation standard is recorded on the high-density recording layer 115, while an image conforming to the DVD standard and having a resolution lower than the high definition image is recorded on the middle-density recording layer 112. In this event, a problem arises in that the data recorded on both recording layers 112, 115 is highly redundant, and the coding efficiency is low.

In the manufacturing process described above, existing manufacturing steps conforming to the DVD standard are mixed with manufacturing steps conforming to the next-generation standard due to the difference in recording density between the middle-density recording layer 112 and the high-density recording layer 115, so that there is also a problem of high facility investment and manufacturing cost required for manufacturing the optical disc 100.

### SUMMARY OF THE INVENTION

In view of the foregoing, it is an object of the present invention to provide a multi-layered optical disc, an optical disc reproducing apparatus, and an optical disc recording apparatus which are capable of reducing the redundancy of recorded information. It is a further object of the present invention to provide a multi-layered optical disc, an optical disc reproducing apparatus, and an optical disc recording apparatus which are capable of reducing the facility investment and manufacturing cost.

According to one aspect of the present invention, there is provided an optical disc recording apparatus for recording an image signal on a multi-layered optical disc having a plurality of recording layers. The optical disc recording apparatus includes a signal generator for sampling a high-resolution image signal at a predetermined rate to generate a low-resolution image signal, and generating a part of the high-resolution image signal except for the low-resolution image signal as a modified image signal; a first encoder for encoding the low-resolution image signal with a first coding scheme to generate a first encoded signal; a second encoder for encoding the modified image signal with a second coding scheme different from the first coding scheme to generate a second encoded signal; a signal modulator for modulating the first encoded signal and the second encoded signal to generate a first modulated signal and a second modulated signal, respectively; and an optical pickup unit for writing the first modulated signal into a first recording layer of the multi-layered optical disc, and writing the second encoded signal into a second recording layer of the multi-layered optical disc.

According to another aspect of the present invention, there is provided an optical disc reproducing apparatus for reproducing an image signal from a multi-layered optical disc having a plurality of recording layers. The optical disc reproducing apparatus includes an optical pickup unit for reading a first modulated signal from a first recording layer of the multi-layered optical disc, and reading a second modulated signal from a second recording layer of the multi-layered optical disc; a signal demodulator for demodulating the first modulated signal and the second modulated signal to generate a first encoded signal and a second encoded signal, respectively; a first decoder for decoding the first encoded signal with a first decoding scheme to generate a low-resolution image signal; a second decoder for decoding the second encoded signal with a second decoding scheme different from the first decoding scheme to generate a modified image signal; and a signal combiner for combining the low-resolution image signal with the modified image signal to generate a high-resolution image signal.

According to yet another aspect of the present invention there is provided a multi-layered optical disc having a plurality of recording layers. The multi-layered optical disc includes a first recording layer for recording a first encoded signal generated by encoding a low-resolution image signal generated by sampling a high-resolution image signal at a predetermined rate with a first coding scheme; and a second recording layer for recording a second encoded signal generated by encoding a part of the high-resolution image signal except for the low-resolution image signal with a second coding scheme different from the first coding scheme.

Further features of the present invention, its nature and various advantages will be more apparent from the accompanying drawings and the following detailed description of the preferred embodiments.

### BRIEF DESCRIPTION OF THE DRAWINGS

FIG. 1 is a cross-sectional view schematically illustrating the structure of an optical disc disclosed in Japanese Patent Kokai No. 2001-176129;

FIG. 2 is a block diagram schematically illustrating a configuration of an optical disc recording/reproducing apparatus which is an embodiment of the present invention;

FIG. 3 is a cross-sectional view schematically illustrating a structure of a multi-layered optical disc which is an embodiment of the present invention;

FIG. 4 is a diagram schematically illustrating a high-resolution image;

FIG. 5 is a diagram schematically illustrating a low-resolution image;

FIG. 6 is a diagram schematically illustrating a modified image; and

FIG. 7 is a flow chart schematically illustrating a procedure of reproduction processing in the optical disc recording/reproducing apparatus.

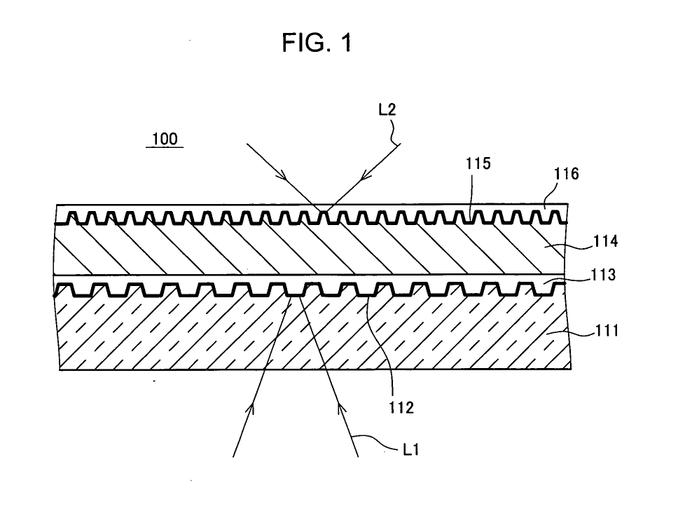

### DETAILED DESCRIPTION OF THE INVENTION

Various exemplary embodiments of the present invention will now be described.

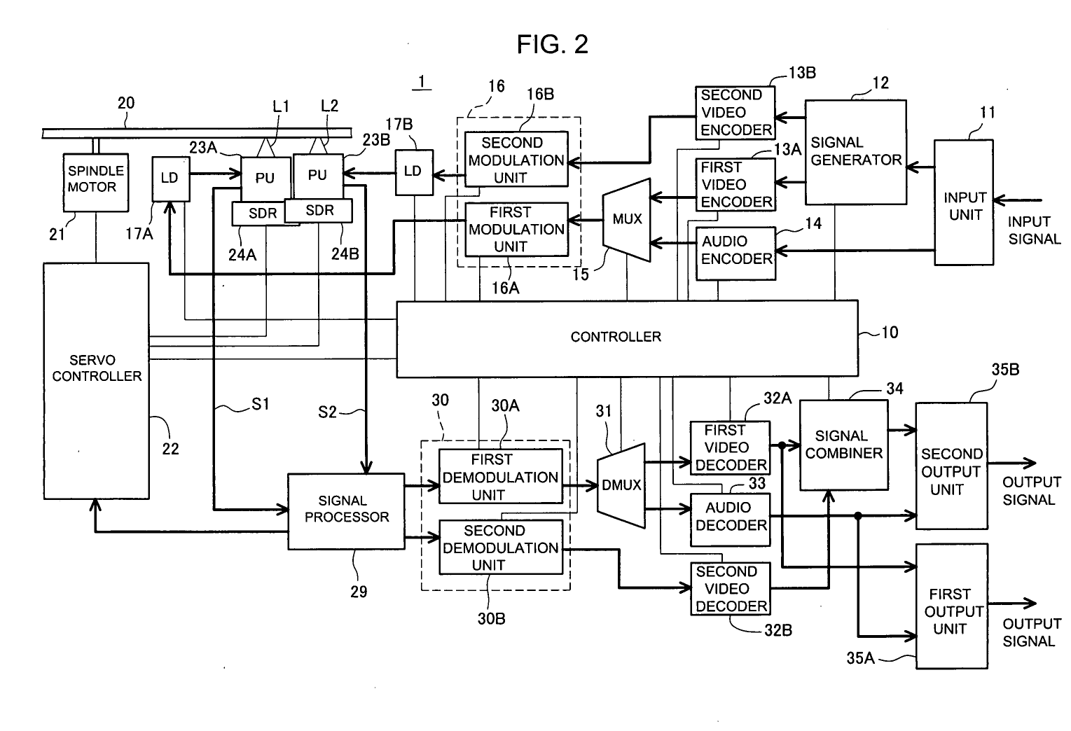

FIG. 2 is a block diagram schematically illustrating a configuration of an optical disc recording/reproducing apparatus 1 which is an embodiment of the present invention. The optical recording/reproducing apparatus 1 has a function of recording a video signal (moving image signal) and an audio signal on a multi-layered optical disc 20, and a function of reproducing a video signal and an audio signal recorded on the multi-layered optical disc 20.

The multi-layered optical disc 20 has a plurality of recording layers, and is a two-layered optical disc having a first recording surface 41A and a second recording surface 43A which have recording areas corresponding to the same recording density. It is to be noted that the term “surface” of a layer means not only an exterior surface not covered by other layers, but also an interior surface covered by other layers. The two-layered optical disc 20 is made of polycarbonate (PC), poly methyl methacrylate (PMMA), optical glass, or the like, and has a first disc substrate 40 and a second disc substrate 44 which oppose each other. One main surface of the first disc substrate 40 forms a land and groove pattern conforming to a predetermined optical disc standard, and has spiral or concentric guiding grooves or recording pits. The first disc substrate 40 having such land and groove pattern can be formed by an injection molding method using a stamper. A first recording layer 41 having a first recording surface 41A is formed on the main surface of the land and groove pattern. When the two-layered optical disc 20 is exclusively for reproduction, the first recording layer 41 is comprised only of a metal reflective film (semi-reflective transparent film) made of gold (Au), silver (Ag), nickel (Ni), aluminum (Al), or the like. When the two-layered optical disc 20 is a recording/reproducing disc, the first recording layer 41 is made by sequentially depositing a metal reflective film (semi-reflective transparent film) and a recording film on the main surface of the first disc substrate 40. The metal reflective film which forms part of the recording layer 41 has such a thickness that the metal reflective film transmits part of incident light and reflects the remaining.

On the other hand, one main surface of the second disc substrate 44 forms a land and groove pattern conforming to a predetermined optical disc standard, and has spiral or concentric guiding grooves or recording pits. The second disc substrate 44 can be formed by an injection molding method using a stamper in a manner similar to the first disc substrate 40. A second recording layer 43 having a second recording surface 43A is formed on the main surface of the land and groove pattern. When the two-layered optical disc is exclusively for reproduction, the second recording layer 43 is comprised only of a metal reflective film (total reflective film) made of gold (Au), silver (Ag), nickel (Ni), aluminum (Al), or the like. When the two-layered optical disc 20 is a recording/reproducing disc, the second recording layer 43 is made by sequentially depositing a metal reflective film (total reflective film) and a recording film on the main surface of the second disc substrate 44. The metal reflective film which forms part of the second recording layer 43 may be formed with such a thickness that the metal reflective film transmits part of incident light and reflects the remaining.

The second disc substrate 44 and first disc substrate 40 are integrated through an optically transparent layer (adhesive layer) 42 such that the first recording surf ace 41A opposes the second recording surface 43A. An ultraviolet curing resin, an optically curing film, or the like may be used as the optically transparent layer 42.

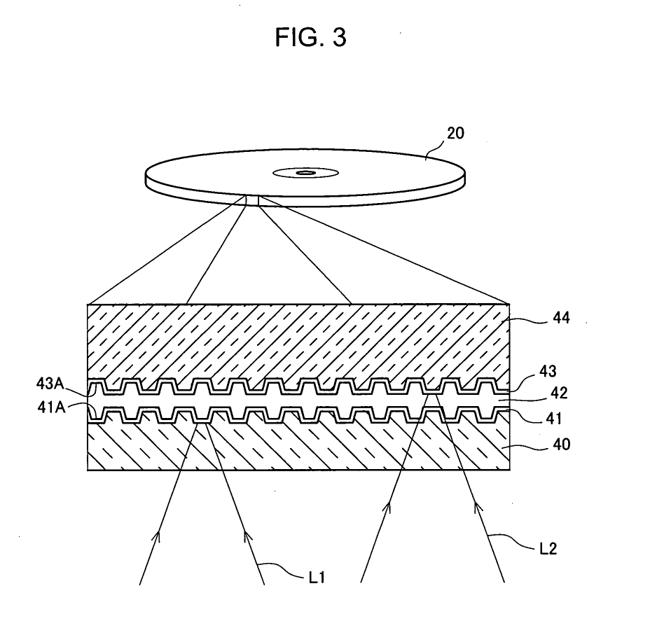

The first recording surface 41A, one of the recording surfaces of the two-layered optical disc 20 shown in FIG. 3, has a recording area which includes guiding grooves and recording pits which correspond to a recording density conforming to the optical disc standard, while the other second recording surface 43A has a recording area which corresponds to a recording density conforming to the same optical disc standard as the first recording surface 41A. Therefore, the first recording surface 41A and second recording surface 43A have the same recording density.

While the two-layered optical disc 20 shown in FIG. 3 is formed with the recording surfaces 41A, 43A having the same recording density, the first recording surface 41A may have a recording density different from that of the second recording surface 43A in an alternative. Specifically, the recording density of the first recording surface 41A may conform to the existing optical disc standard, while the recording density of the second recording surface 43A may conform to the next-generation optical disc standard, so that the recording density of the first recording surface 41A may be lower than the recording density of the second recording surface 43A.

Next, the optical disc recording/reproducing apparatus 1 comprises a spindle motor 21, a first optical pickup (PU) 23A, a first slider (SDR) 24A, a first laser driver (LD) 17A, a second optical pickup (PU) 23B, a second slider (SDR) 24B, a second laser driver (LD) 17B, and a servo controller 22. The first laser driver 17A, second laser driver 17B, and servo controller 22 are controlled by a controller 10. The controller 10 is an integrated circuit which contains a ROM for storing an initial program and a control program required for operation of the system, a microprocessor, an SRAM, a bus for transmitting signals, an input/output interface, and the like. The optical pickup section according to the present invention may be comprised of the first optical pickup 23A, first slider 24A, first laser driver 17A, second optical pickup 23B, second slider 24B, and second laser driver 17B.

The first optical pickup 23A has a function of writing a signal into the first recording surface 41A of the multi-layered optical disc 20 or reading a signal from the first recording surface 41A, while the second optical pickup 23B has a function of writing a signal into the second recording surface 43A of the multi-layered optical disc 20, or reading a signal from the second recording surface 43A. The first optical pickup 23A comprises a laser light source, an objective lens for focusing light emitted from the laser light source and irradiating the multi-layered optical disc 20 with the focused light, and a photodetector for detecting return light from the multi-layered optical disc 20. The second optical pickup 23B also has a similar configuration to the first optical pickup 23A. The laser light sources of the first optical pickup 23A and second optical pickup 23B oscillate laser light at the same center wavelength in accordance with driving signals supplied from the first laser driver 17A and second laser driver 17B, respectively. The first pickup 23A and second pickup 23B are carried on the first slider 24A and second slider 24B, respectively. The first slider 24A and second slider 24B include feeding mechanisms for radially moving the first optical pickup 23A and second optical pickup 23B, respectively.

In the first optical pickup 23A and second optical pickup 23B, the photodetectors contained therein detect return light from the recording layers 41A, 43A of the multi-layered optical disc 20, and output resulting detection signals S1, S2 to a signal processor 29 in parallel. The signal processor 29 generates a TE signal (tracking error signal), an FE (focus error) signal, and an RF signal using the detection signal S1, and outputs these signals to the servo controller 22. In parallel with this, the signal processor 29 generates a TE signal, an FE signal, and an RF signal using the detection signal S2, and outputs these signals to the servo controller 22. The servo controller 22 conducts a tracking servo control and a focus servo control for individually adjusting focused positions of laser light L1, L2 irradiated to the recording layers 41A, 43A of the multi-layered optical disc 20, based on the TE signal and FE signal. The spindle motor 21 rotates the loaded multi-layered optical disc 20 at a predetermined rotational speed. The servo controller 22 controls the spindle motor 21 so as to compensate the multi-layered optical disc 20 for rotation errors.

The optical disc recording/reproducing apparatus 1 comprises circuits for generating modulated signals to be written into the recording surfaces 41A, 43A of the multi-layered optical disc 20, including an input unit 11, a signal generator 12, a first video encoder 13A, a second video encoder 13B, an audio encoder 14, a multiplexer (MUX) 15, and a signal modulator 16. The signal modulator 16 includes a first modulation unit 16A and a second modulation unit 16B. These circuits are controlled by the controller 10.

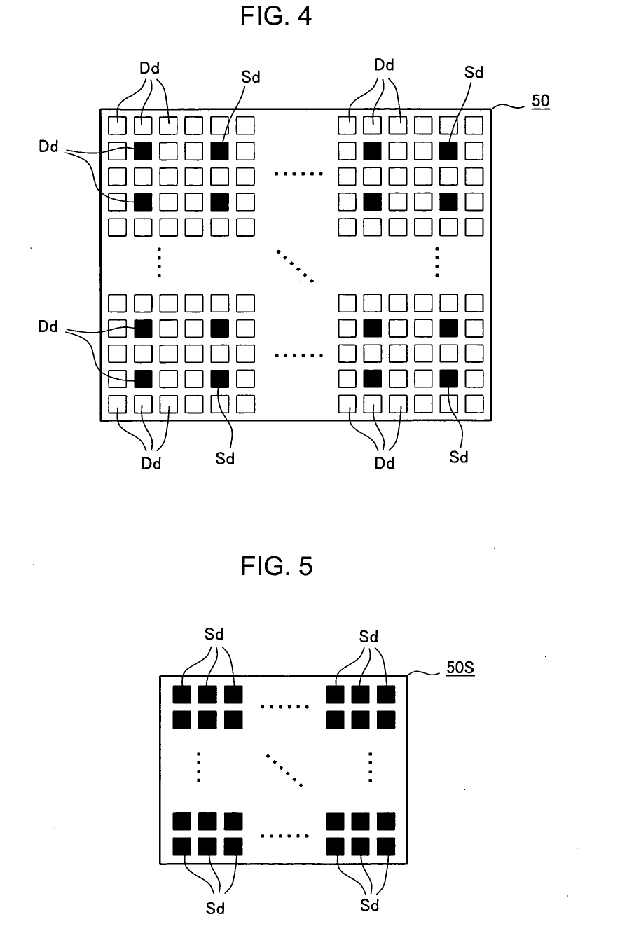

The input unit 11 digital-to-analog converts an external input signal to a digital signal, and separates the digital signal into a video signal (high-resolution video signal), an audio signal, and a synchronization signal. The video signal is supplied to the signal generator 12; the audio signal to the audio encoder 14; and the synchronization signal to the signal generator 12, audio encoder 14, and the like. The video signal comprises a plurality of temporally continuous frames or fields. FIG. 4 is a diagram schematically illustrating one frame of high-resolution image (high definition image) 50 in the video signal. The frame 50 has a high resolution of M pixels (M is a natural number) in the horizontal direction and N pixels (N is a natural number) in the vertical direction, and is composed of multiple pixel data Dd, Dd, . . . , Sd, . . . arranged in a two-dimensional format.

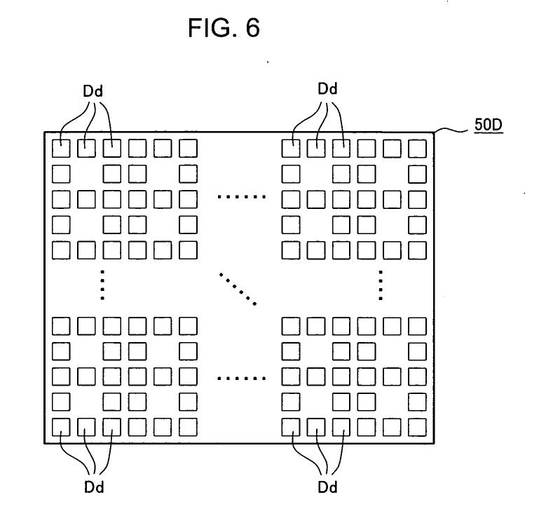

The signal generator 12 samples an input video signal at a predetermined rate to generate a low-resolution video signal (low-resolution image signal) which is supplied to the first video encoder 13A. Simultaneously, the signal generator 12 generates a part of the input video signal except for the low-resolution video signal as a modified video signal which is supplied to the second video encoder 13B. For example, in the frame 50 shown in FIG. 4, when pixel data Sd, Sd, . . . indicated by black circles on an even-numbered horizontal line are sampled, a low-resolution image 50S shown in FIG. 5 is generated to make up a low-resolution video signal. An image of the high-resolution image 50 shown in FIG. 4 except for pixel data Sd, Sd, . . . becomes a modified image 50D composed only of pixel data Dd, Dd, . . . , as schematically illustrated in FIG. 6, to make up a modified image signal. The signal generator 12 may include a selector for selecting an input video signal in units of pixels for generating a low-resolution video signal and a modified image signal, or may include a sampling circuit for down-sampling (i.e., decimating) an input video signal at a predetermined rate.

The video encoder 13A encodes a low-resolution video signal with an existing moving image coding scheme such as H.261 or the like, and outputs the encoded signal to the multiplexer 15 at a predetermined timing. The audio encoder 14 encodes an input audio signal and outputs the encoded audio signal to the multiplexer 15 at a predetermined timing. The multiplexer 15 multiplexes the encoded signals input thereto from the first video encoder 13A and audio encoder 14 under the control of the controller 10, and outputs the resulting multiplexed signal to the first modulation unit 16A. The first modulation unit 16A modulates the multiplexed signal to generate a modulated signal in a predetermined format, the modulated signal being supplied to the first laser driver 17A. The first optical pickup 23A generates a light beam L1 which is modulated in intensity in accordance with a driving signal supplied from the first laser driver 17A, and irradiates the first recording surface 41A (FIG. 3) of the multi-layered optical disc 20 with the optical beam L1. As a result, the low-resolution video signal and audio signal are recorded on the first recording surface 41A with the existing moving image coding scheme.

The second video encoder 13B, on the other hand, encodes a modified image signal input from the signal generator 12 with a next-generation moving image decoding scheme such as H.264 (ISO/IEC14496-10), and outputs the encoded signal to the second modulation unit 16B. The second modulation unit 16B modulates the encoded signal to generate a modulated signal in a predetermined format which is supplied to the second laser driver 17B. The second optical pickup 23B generates a light beam L2 which is modulated in intensity in accordance with a driving signal supplied from the second laser driver 17B, and irradiates the second recording surface 43A (FIG. 3) of the multi-layered optical disc 20 with the light beam L2. As a result, the modified image signal is recorded on the second recording surface 43A with the next-generation moving image coding scheme.

As described above, a low-resolution video signal is recorded on the first recording surface 41A, i.e., one of the two recording surfaces of the multi-layered optical disc 20, and a modified image signal is simultaneously recorded on the second recording surface 43A, i.e., the other of the two recording surfaces, in parallel with the low-resolution video signal. Accordingly, information with low redundancy can be efficiently recorded on the multi-layered optical disc 20 in a short time. For example, in a 1080i format (an interlace format defined by 1920×1080 pixels per frame), approximately 16% of redundancy can be eliminated by sampling one of six pixels to generate a low-resolution video signal, and approximately 50% of redundancy can be eliminated in a 480p format (a progressive format defined by 720×480 pixels per frame).

Accordingly, since a low-resolution video signal and an audio signal can be encoded with the existing moving image coding scheme and recorded on the first recording surface 41A, it is possible to provide the multi-layered optical disc 20 which has the backward compatibility with the existing coding scheme. Further, in the multi-layered optical disc 20 shown in FIG. 3, when the first recording surface 41A and second recording surface 43A are formed so as to have a recording density conforming to the existing optical disc standard, a backward compatible multi-layered optical disc can be manufactured at a low cost by utilizing an existing manufacturing process without requiring additional investments for manufacturing facilities.

Next, the optical disc recording/reproducing apparatus 1 comprises circuits for reproducing information recorded on the multi-layered optical disc 20, including a signal demodulator 30, a demultiplexer (DMUX) 31, a first video decoder 32A, a second video decoder 32B, an audio decoder 33, a signal combiner 34, a first output unit 35A, and a second output unit 35B. The signal demodulator 30 is comprised of a first demodulation unit 30A and a second demodulation unit 30B. Likewise, these circuits are controlled by the controller 10.

As described above, the signal processor 29 generates RF signals using the detection signals S1, S2 supplied from the first pickup 23A and second optical pickup 23B, respectively. An RF signal generated from one detection signal S1 is called the “first modulated signal,” while an RF signal generated from the other detection signal S1 is called the “second modulated signal.” The first demodulation unit 30A demodulates the first modulated signal to generate an encoded signal which is supplied to the demultiplexer 31. The demultiplexer 31 separates the encoded signal into an audio encoded signal and a video encoded signal, and supplies the audio encoded signal to the audio decoder 33, and the video encoded signal to the first video decoder 32A.

The first video decoder 32A, which conforms to the existing moving image decoding scheme, decodes the video encoded signal to generate a low-resolution video signal which is supplied to the signal combiner 34 and first output unit 35A in parallel. The audio decoder 33 decodes the audio encoded signal to generate an audio signal which is supplied to the first output unit 35A and second output unit 35B in parallel. Then, the first output unit 35A digital-to-analog converts the low-resolution video signal and audio signal input from the first video decoder 33A and audio decoder 33, respectively, and outputs the resulting analog signals to the outside.

The second demodulation unit 30B demodulates the second modulated signal to generate an encoded signal which is supplied to the second video decoder 32B. The second video decoder 32B, which conforms to a composite standard including the next-generation moving image decoding scheme, decodes the encoded signal input from the second demodulator 30B to generate the aforementioned modified image signal which is supplied to the signal combiner 34. The signal combiner 34 combines the low-resolution video signal input from the first video decoder 32A with the modified video signal input from second video decoder 32B to generate a high-resolution video signal which is supplied to the first output unit 35A. Specifically, the signal combiner 34 can reconstruct the high-resolution video signal by inserting the low-resolution video signals into a series of the modified image signals. In this way, for example, from the low-resolution image 50S shown in FIG. 5 and the modified image 50D shown in FIG. 6, the high-resolution image 50 shown in FIG. 4 is reconstructed. Then, the first output unit 35A digital-to-analog converts the high-resolution video signal and audio signal, and outputs the analog signal to the outside.

As described above, the optical disc recording/reproducing apparatus 1 can reproduce a low-resolution video signal recorded on the first recording surface 41A of the multi-layered optical disc 30, reproduce a modified image signal recorded on the second recording surface 43A simultaneously and in parallel with the low-resolution video signal, and combines the low-resolution video signal with the modified image signal to reproduce a high-resolution video signal.

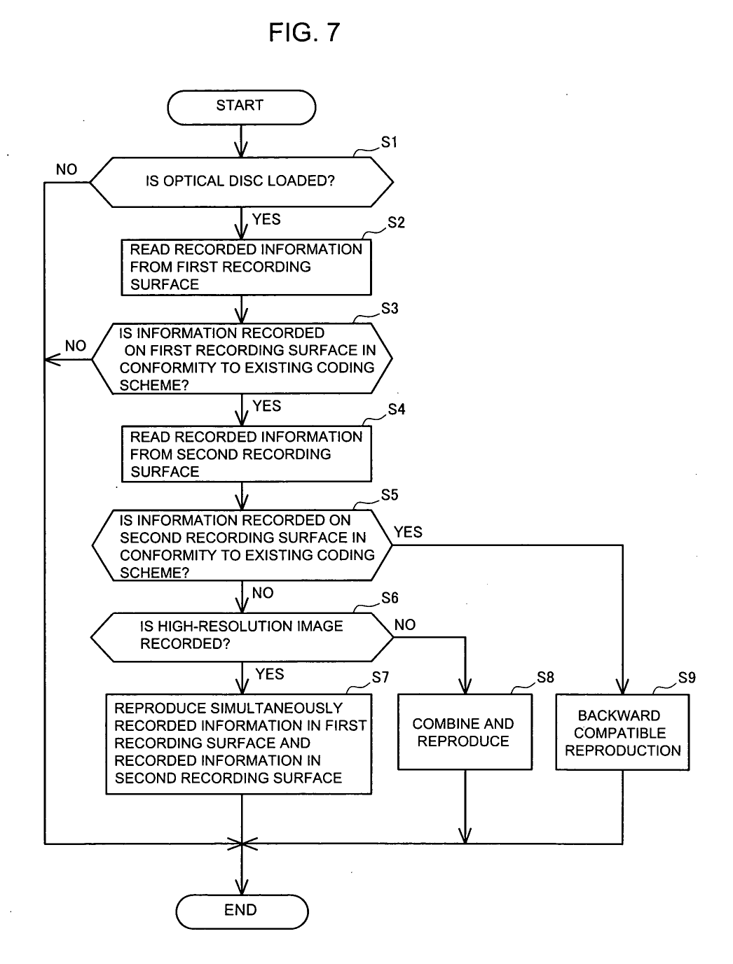

Next, one procedure of reproduction processing in the optical disc recording/reproducing apparatus 1 will be outlined with reference to FIG. 7. Referring to FIG. 7, the controller 10 determines whether or not the multi-layered optical disc 20 is loaded (step S1), and terminates the reproduction processing if the multi-layered optical disc 20 is not loaded. On the other hand, upon determining that the multi-layered optical disc 20 is loaded, the controller 10 instructs the first optical pickup 23A to read recorded information in the first recording surface 41A of the multi-layered optical disc 20 (step S2). In response to this instruction, the first optical pickup 23A places the focal point of the objective lens on the first recording surface 41A of the multi-layered optical disc 20, irradiates the first recording surface 41A with laser light L1, and detects its return light to generate a detection signal S1 which is supplied to the signal processor 29. The first demodulation unit 30A demodulates the signal input from the signal processor 29 to generate an encoded signal. This encoded signal is transmitted to the first video decoder 32A through the demultiplexer 31 for decoding.

Next, the controller determines based on decoded information supplied from the first video decoder 32A whether or not information has been recorded on the recording surface 41A in conformity to the existing coding scheme (step S3), and terminates the reproduction processing if it determines that such information is not recorded on the recording surface 41A. On the other hand, upon determining that information is recorded on the recording surface 41A, the controller 10 instructs the first optical pickup 23A and second optical pickup 23B to read recorded information in the second recording surface 43A (step S4). In response to this instruction, the first optical pickup 23A irradiates the second recording surface 43A of the multi-layered optical disc 20 with the laser light L1, and detects its return light to generate a detection signal S1 which is supplied to the signal processor 29. The first demodulation unit 30A demodulates the signal input from the signal processor 29 to generate an encoded signal. This encoded signal is transmitted to the video decoder 32A for decoding. In parallel, the second optical pickup 23B irradiates the second recording surface 43A with the laser light L2, and detects its return light to generate a detection signal S2 which is supplied to the signal processor 29. The second demodulator 30B demodulates the signal input from the signal processor 29 to generate an encoded signal. This encoded signal is transmitted to the second video decoder 32B for decoding.

Next, the controller 10 determines based on decoded information supplied from the first video decoder 32A whether or not information is recorded on the second recording surface 43A in conformity to the existing coding scheme (step S5). Upon determining that such information is recorded on the second recording surface 43A, the controller 10 determines that information conforming to the existing coding scheme is recorded both on the first recording surface 41A and on the second recording surface 43A, and instructs the first optical pickup 23A to sequentially reproduce the information recorded on the first recording surface 41A and second recording surface 43A (backward compatible reproduction processing: step S9). In response to this instruction, the first optical pickup 23A first places the focal point of the objective lens on the first recording surface, irradiates the first recording surface 41A with the laser light L1, and detects its return light to generate a detection signal S1 which is supplied from the first optical pickup 23A. In this way, the modulated signal read from the first recording surface 41A is demodulated by the first demodulation unit 30A, decoded by the first video decoder 32A, and then supplied to the outside through the first output unit 35A. After the recorded information has been read from the first recording surface 41A, the first optical pickup 23A switches the focal point of the objective lens from the first recording surface 41A to the second recording surface 43A, irradiates the second recording surface 43A with the laser light L1, and detects its return light to generate a detection signal S1 which is supplied from the first optical pickup 23. In this way, the modulated signal read from the second recording surface 43A is demodulated by the first demodulation unit 30A, decoded by the first video decoder 32A, and supplied to the outside through the first output unit 35A.

On the other hand, upon determining at step 5 that no information is recorded on the second recording surface 43A in conformity to the existing encoding scheme, the controller 10 determines based on decoded information supplied from the second video decoder 32B whether or not a high-resolution image is recorded on the second recording surface 43A in conformity to the next-generation coding scheme (step S6). When the controller 10 determines at step S6 that the high-resolution image is recorded on the second recording surface 43A, the controller 10 instructs the first optical pickup 23A and second optical pickup 23B to simultaneously reproduce information recorded on the first recording surface 41A and second recording surface 43A, respectively, in parallel (step S7). In response to this instruction, the first optical pickup 23A places the focal point of the objective lens on the first recording surface 41A and irradiates the first recording surface 41A with the laser light L1, while the second optical pickup 23B places the focal point of the objective lens on the second recording surface 43A, and irradiates the surface 43A with the laser light L2. In this way, the modulated signal read from the first recording surface 41A is demodulated by the first demodulator 30A, decoded by the first video decoder 32A, and supplied to the outside through the first output unit 35A. Simultaneously, the modulated signal read from the second recording surface 43A is demodulated by the second demodulator 30B, and decoded by the second video decoder 32B. The signal combiner 34 outputs the high-resolution video signal input from the second video decoder 32B to the second output unit 35B as it is.

On the other hand, if the controller determines at step S6 that no high-resolution image is recorded on the second recording surface 43A, the controller 10 determines that the modified image is recorded on the second recording surface 43A, and instructs the first optical pickup 23A and second optical pickup 23B to combine the modified image signal with a low-resolution video signal for reproduction of a high-resolution video signal (step S8). In response to this instruction, the first optical pickup 23A places the focal point of the objective lens on the first recording surface 41A, and irradiates the second recording surface 41A with the laser light L1, while the second optical pickup 23B places the focal point of the objective lens on the second recording surface 43A and irradiates the surface 43A with the laser light L2. In this way, the modulated signal read from the first recording surface 41A is demodulated by the first demodulation unit 30A, decoded by the first video decoder 32A, and transmitted to the signal combiner 34. Simultaneously, the modulated signal read from the second recording surface 43A is demodulated by the second demodulator 30B, decoded by the second video decoder 32B, and transmitted to the signal combiner 34. The signal combiner 34 combines the low-resolution video signal input from the first video decoder 32A with the modified image signal input from the second video decoder 32B to reproduce a high-resolution video signal which is supplied to the second output unit 35B.

Several embodiments of the present invention have been described above. While the foregoing embodiments employ the two independent optical pickups 23A, 23B, they may be replaced with a single optical pickup which can simultaneously irradiate the recording surfaces 41A, 43A with two beams of laser light L1, L2, respectively, to simultaneously read signals from the two recording surfaces 41A, 43A in parallel, or to simultaneously write signals into the two recording surfaces 41A, 43A.

It is understood that the foregoing description and accompanying drawings set forth the preferred embodiments of the present invention at the present time. Various modifications, additions and alternatives will, of course, become apparent to those skilled in the art in light of the foregoing teachings without departing from the spirit and scope of the disclosed invention. Thus, it should be appreciated that the invention is not limited to the disclosed embodiments but may be practiced within the full scope of the appended claims.

This application is based on a Japanese Patent Application No. 2004-050291 which is hereby incorporated by reference.

1. An optical disc recording apparatus for recording an image signal on a multi-layered optical disc having a plurality of recording layers, comprising:
a signal generator for sampling a high-resolution image signal at a predetermined rate to generate a low-resolution image signal, and generating a part of the high-resolution image signal except for the low-resolution image signal as a modified image signal;
a first encoder for encoding the low-resolution image signal with a first coding scheme to generate a first encoded signal;
a second encoder for encoding the modified image signal with a second coding scheme different from the first coding scheme to generate a second encoded signal;
a signal modulator for modulating the first encoded signal and the second encoded signal to generate a first modulated signal and a second modulated signal, respectively; and
an optical pickup unit for writing the first modulated signal into a first recording layer of the multi-layered optical disc, and writing the second encoded signal into a second recording layer of the multi-layered optical disc.

2. An optical recording apparatus according to claim 1, wherein said optical pickup unit includes a first optical pickup for writing the first modulated signal into the first recording layer, and a second optical pickup for writing the second encoded signal into the second recording layer, wherein said first optical pickup and said second optical pickup operate independently of each other.

3. An optical disc recording apparatus according to claim 1, wherein said first recording layer and said second recording layer have recording areas which correspond to the same recording density.

4. An optical disc recording apparatus according to claim 1, wherein said first recording layer of the multi-layered optical disc has a recording area which supports a first recording density, and said second recording layer has a recording area which corresponds to a second recording density different from the first recording density.

5. An optical disc recording apparatus according to claim 4, wherein said first recording density is lower than said second recording density.

6. An optical disc reproducing apparatus for reproducing an image signal from a multi-layered optical disc having a plurality of recording layers, comprising:
an optical pickup unit for reading a first modulated signal from a first recording layer of the multi-layered optical disc, and reading a second modulated signal from a second recording layer of the multi-layered optical disc;
a signal demodulator for demodulating the first modulated signal and the second modulated signal to generate a first encoded signal and a second encoded signal, respectively;
a first decoder for decoding the first encoded signal with a first decoding scheme to generate a low-resolution image signal;
a second decoder for decoding the second encoded signal with a second decoding scheme different from the first decoding scheme to generate a modified image signal; and
a signal combiner for combining the low-resolution image signal with the modified image signal to generate a high-resolution image signal.

7. An optical disc reproducing apparatus according to claim 6, wherein said optical pickup unit includes a first optical pickup for reading the first modulated signal from the first recording layer, and a second optical pickup for reading the second encoded signal from the second recording layer, wherein said first optical pickup and said second optical pickup operate independently of each other.

8. An optical disc reproducing apparatus according to claim 6, wherein said first recording layer and said second recording layer have recording areas which correspond to the same recording density.

9. An optical disc reproducing apparatus according to claim 6, wherein said first recording layer of the multi-layered optical disc has a recording area which corresponds to a first recording density, and said second recording layer has a recording area which corresponds to a second recording density different from the first recording density.

10. An optical disc reproducing apparatus according to claim 9, wherein said first recording density is lower than said second recording density.

11. A multi-layered optical disc having a plurality of recording layers, comprising:
a first recording layer for recording a first encoded signal generated by encoding a low-resolution image signal generated by sampling a high-resolution image signal at a predetermined rate with a first coding scheme; and
a second recording layer for recording a second encoded signal generated by encoding a part of the high-resolution image signal except for the low-resolution image signal with a second coding scheme different from the first coding scheme.

12. A multi-layered optical disc according to claim 11, wherein said first recording layer and said second recording layer have recording areas which correspond to the same recording density.

13. A multi-layered optical disc according to claim 11, wherein said first recording layer of the multi-layered optical disc has a recording area which corresponds to a first recording density, and said second recording layer has a recording area which corresponds to a second recording density different from the first recording density.

14. A multi-layered optical disc according to claim 13, wherein said first recording density is lower than said second recording density.
